(19) United States
(12) Patent Application Publication
(10) Pub. No.: US 2013/0165127 A1
(43) Pub. Date: Jun. 27, 2013

(54) BASE STATION, COMMUNICATION SYSTEM AND HANDOVER DESTINATION DETERMINATION METHOD

(71) Applicant: Hiroshi Ikegami, Yokohama (JP)

(72) Inventor: Hiroshi Ikegami, Yokohama (JP)

(73) Assignee: KYOCERA CORPORATION, Kyoto (JP)

(21) Appl. No.: 13/812,425

(22) PCT Filed: Jul. 27, 2011
(86) PCT No.: PCT/JP2011/004256

§ 371 Date: Feb. 12, 2013

(30) Foreign Application Priority Data
Jul. 28, 2010 (JP) 2010-169829

(51) Int. Cl. H04W 36/08

(52) U.S. Cl. CPC H04W 36/08
USPC 455/438

(57) ABSTRACT

A base station, a communication system and a handover destination determination method for determining a target base station that is highly likely to be able to perform a MIMO communication, are provided.

According to the present invention, a base station 103a includes a base station control unit that, for handover of a radio communication terminal 101, determines a neighboring base station capable of performing the MIMO communication based on position information of the radio communication terminal 101 and MIMO communication available area information of neighboring base stations 103b and 103c adjacent to the base station itself.

### CROSS REFERENCE TO RELATED APPLICATION

This application claims priority to and the benefit of Japanese Patent Application No. 2010-169829 (filed on Jul. 28, 2010), the entire contents of which are incorporated herein by reference.

### TECHNICAL FIELD

The embodiment herein relates to a base station, a communication system and a handover destination determination method, and more specifically, to a base station that may perform a MIMO communication, the communication system and the handover destination determination method.

### BACKGROUND

As a next generation radio communication method of a world standard, an LTE (Long Term Evolution) system is standardized by 3GPP (3rd Generation Partnership Project). The LTE system includes a radio communication terminal UE (User Equipment), a base station eNB (evolved Node B) and EPC (Evolved Packet Core) serving as an IP (Internet Protocol)-based core network.

In the LTE system, a MIMO (Multiple Input Multiple Output) communication is performed to transmit and receive a great amount of data. MIMO is a technique that widens a frequency band for transmitting and receiving the data by combining each of a plurality of transmission antennas and a plurality of reception antennas, whereby a faster communication is achieved. However, in order to perform the MIMO communication, it is required that the plurality of antennas may transmit and receive radio waves and, simultaneously, these antennas are highly correlated with each other. Accordingly, the MIMO communication is not always available between the radio communication terminal and the base station. Also, when the radio communication changes the base station serving an access point by handover during the MIMO communication, the MIMO communication may possibly be discontinued.

Here, a system of the handover by the LTE system will be described with reference to FIG. 6 (for example, see Non-Patent Documents 1 and 2 listed below). The radio communication terminal measures radio field intensity of the base station serving as the access point (source base station (Source eNB)) and neighboring base stations A, B (Measurement) and transmits results of the measurement in a measurement report (Measurement Report) message to the source base station serving as the access point. The source base station receives the measurement report message and, based on the radio field intensity, determines whether the radio communication terminal should change its access point, that is, whether the radio communication terminal should perform the handover. The source base station, when there is a neighboring base station having higher radio field intensity than that of the source base station, determines this neighboring base station as a handover destination (target base station (Target eNB)). Then, the radio communication terminal establishes a radio link with the target base station and starts a communication. When the target base station as the handover destination has a plurality of antennas that may transmit and receive the radio waves and highly correlate with each other, the radio communication terminal and the target base station may perform the MIMO communication.

### NON-PATENT DOCUMENTS

Non-Patent Document 1: 3GPP TS 36.331

Non-Patent Document 2: 3GPP TS 36.423

### SUMMARY

According to a related handover destination determination method, however, availability of the MIMO communication is not a factor to determine the target base station (handover destination). That is, the handover does not conventionally assure the MIMO communication after the handover. Therefore, when the radio communication terminal performs the handover during the MIMO communication transmitting/receiving a large amount of data, the MIMO communication may possibly be discontinued due to the handover, regardless of a user's wish to maintain the MIMO communication. Discontinuation of the MIMO communication degrades throughput.

Accordingly, in consideration of the above related technique, the following embodiment provides a base station, a communication system and a handover destination determination method for determining a target base station that is more likely to be able to perform the MIMO communication.

### Solution to Problem

In order to solve the above problem, a base station performing a MIMO (Multiple Input Multiple Output) communication with a radio communication terminal according to a first aspect includes:

a base station control unit configured to, for handover of the radio communication terminal, based on position information of the radio communication terminal and MIMO communication available area information of a neighboring base station adjacent to the base station, to determine a neighboring base station capable of performing the MIMO communication.

Preferably, the base station further includes:

a base station communication unit configured to communicate with the neighboring base station; and

a base station memory unit configured to store the MIMO communication available area information of the neighboring base station received from the neighboring base station by the base station communication unit, wherein

the base station control unit, based on the position information and the MIMO communication available area information stored in the base station memory unit, identifies a neighboring base station that includes the radio communication terminal in a MIMO communication available area and determines the identified neighboring base station as a handover destination capable of performing the MIMO communication.

Also preferably, the MIMO communication available area information of the neighboring base station is updated based on position information of a radio communication terminal with which the neighboring base station has performed the MIMO communication.

A communication system including a radio communication terminal, a base station terminal performing a MIMO (Multiple Input Multiple Output) communication with the radio communication terminal, and a neighboring base station adjacent to the base station according to a second aspect, wherein the base station includes:

a base station communication unit configured to communicate with the neighboring base station; and

a base station control unit configured to, for handover of the radio communication terminal, determine the neighboring base station capable of performing the MIMO communication as a handover destination, and

the neighboring base station includes:

a neighboring base station communication unit configured to communicate with the base station;

a neighboring base station memory unit configured to store MIMO communication available area information of the neighboring base station itself; and

a neighboring base station control unit configured to, when the neighboring base station communication unit receives the position information of the radio communication terminal from the base station communication unit, determine whether the radio communication terminal is positioned in the MIMO communication available area based on the position information and the MIMO communication available area information stored in the neighboring base station memory unit and, when the radio communication terminal is positioned in the MIMO communication available area, to control the neighboring base station communication unit to transmit information indicating that the neighboring base station itself is able to perform the MIMO communication to the base station communication unit.

Preferably, the MIMO communication available area information of the neighboring base station is updated based on position information of a radio communication terminal with which the neighboring base station has performed the MIMO communication.

Although apparatuses are used as solutions as described above, it should be understood that the present invention may also be substantialized by methods, programs and storage media storing the programs that are substantially equivalent to the apparatuses and hence they are included in a scope of the present invention.

For example, as a method substantializing the first aspect of the present invention, a handover destination determination method of a communication system including a radio communication terminal, a base station performing a MIMO (Multiple Input Multiple Output) communication with the radio communication terminal, and a neighboring base station adjacent to the base station, includes a step for handover of the radio communication terminal determining a neighboring base station capable of performing the MIMO communication as a handover destination based on position information of the radio communication terminal and MIMO communication available area information of the neighboring base station.

According to the base station, the communication system and the handover destination determination method described above, based on the position information of the radio communication terminal and the MIMO communication available area information of the neighboring base station, the neighboring base station including the radio communication terminal in the MIMO communication available area is identified and determined as the handover destination. Thereby, the radio communication terminal may maintain the MIMO communication after handover.

### BRIEF DESCRIPTION OF DRAWINGS

FIG. 1 is a schematic diagram of a communication network according to one embodiment;

FIG. 2 is a functional block diagram illustrating a schematic configuration of a base station according to one embodiment;

FIG. 3 is a functional block diagram illustrating a schematic configuration of a radio communication terminal according to one embodiment of the present invention;

FIG. 4 is a flowchart illustrating an operation of the base station according to one embodiment;

FIG. 5 is a sequence diagram illustrating operations before determination on a handover destination according to one embodiment; and

FIG. 6 is a sequence diagram illustrating operations before determination on the handover destination according to a related method.

### DESCRIPTION OF EMBODIMENT

An embodiment will be described with reference to the accompanying drawings.

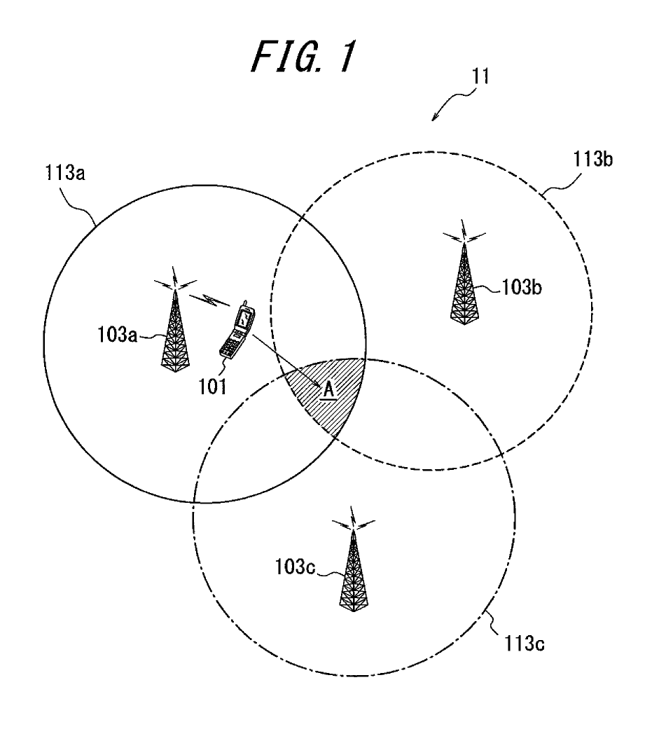

FIG. 1 is a schematic diagram illustrating a communication network according to one embodiment. A communication network 11 includes a radio communication terminal 101 and base stations 103a, 103b and 103c. The radio communication terminal 101 is, for example, a mobile phone or a PHS (Personal Handy-phone System) terminal. The base stations 103a-103c communicate with the radio communication terminal 101 by establishing radio links therewith and are capable of performing a MIMO communication in some communication environments. The base station 103a performing the MIMO communication with the radio communication terminal 101 is referred to as a source base station, and the base stations 103b, 103c adjacent to the source base station are referred to as neighboring base stations. Although two neighboring base stations are used in this embodiment, the number of neighboring base stations is not limited to two. An area 113a represents an area (a cell) where radio waves from the base station 103a may be received. An area 113b represents an area where radio waves from the base station 103b may be received, and an area 113c represents an area where radio waves from the base station 103c may be received. An area A where the areas 113a-113c overlap with each other represents an area where the radio waves from the three base stations 103a-103c may be received. “The base stations are adjacent to each other” means that the cells of the base stations overlap with each other.

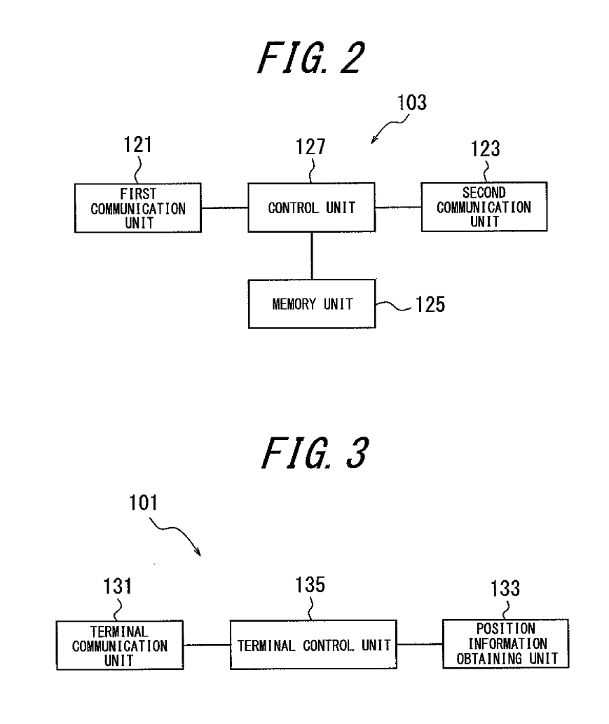

FIG. 2 is a functional block diagram illustrating a schematic configuration of the base station according to one embodiment of the present invention. A base station 103 includes a first communication unit 121, a second communication unit 123, a memory unit 125 and a control unit 127. In the following descriptions of function blocks of the base stations 103a-103c illustrated in FIG. 1, a, b and c are added to reference numerals of the function blocks of the base station 103a, reference numerals of the function blocks of the base station 103b and reference numerals of the function blocks of the base station 103c, respectively. A second communication unit 123a, a memory unit 125a and a control unit 127a of the source base station 103a correspond to a base station communication unit, a base station memory unit and a base station control unit, respectively, described in CLAIMS. Second communication units 123b and 123c of the neighboring base stations 103b and 103c correspond to a neighboring base station communication unit described in CLAIMS. Memory units 125b and 125c of the neighboring base stations 103b and 103c correspond to a neighboring base station memory unit described in CLAIMS. Control units 127b and 127c of the neighboring base stations 103b and 103c correspond to a neighboring base station control unit described in CLAIMS.

The first communication unit 121 exchanges various information with the radio communication terminal 101 and receives, for example, a measurement report message from the radio communication terminal 101. The measurement report message includes radio field intensity of the base stations 103a-103c and position information of the radio communication terminal 101. The second communication terminal 123 exchanges data with the neighboring base stations 103b and 103c connected to the base station 103a via the network and may be, for example, an X2 interface. The X2 interface is an interface between base stations defined by 3GPP.

The memory unit 125 stores various information such as the position information of the radio communication terminal 101 and MIMO communication available area information, as well as functioning as a work memory. The MIMO communication available area information is made up of the position information of the radio communication terminal 101 that may perform the MIMO communication with the base station 103. The MIMO communication available area information may be either static information or dynamic information. The static information is, for example, a theoretical value or a value measured at a certain time (when the base station is newly established and the like) and not updated. The dynamic information is updated according to, for example, a change in radio environment. Here, obtainment of dynamic MIMO communication available area information by the base station 103 will be described. The first communication unit 121 of the base station 103 receives, from the radio communication terminal 101 performing the MIMO communication, the measurement report message including the position information of the radio communication terminal 101. Then, the memory unit 125 stores the obtained position information as MIMO communication available position information. Since the position information of the radio communication terminal 101 for each MIMO communication performed by the base station 103 is stored, the memory unit 125 stores a plurality of MIMO communication available position information. These MIMO communication available position information constitute the MIMO communication available area information, thus the dynamic MIMO communication available area information may be obtained. Also, an area obtained by linear interpolation of two points obtained during the MIMO communication may also be included in the MIMO communication available area information. Further, since older MIMO communication available position information less reflects a current radio environment, the memory unit 125 may not store the MIMO communication available position information older than a certain time. Each of the base stations 103a to 103c holds the MIMO communication available area information of their own.

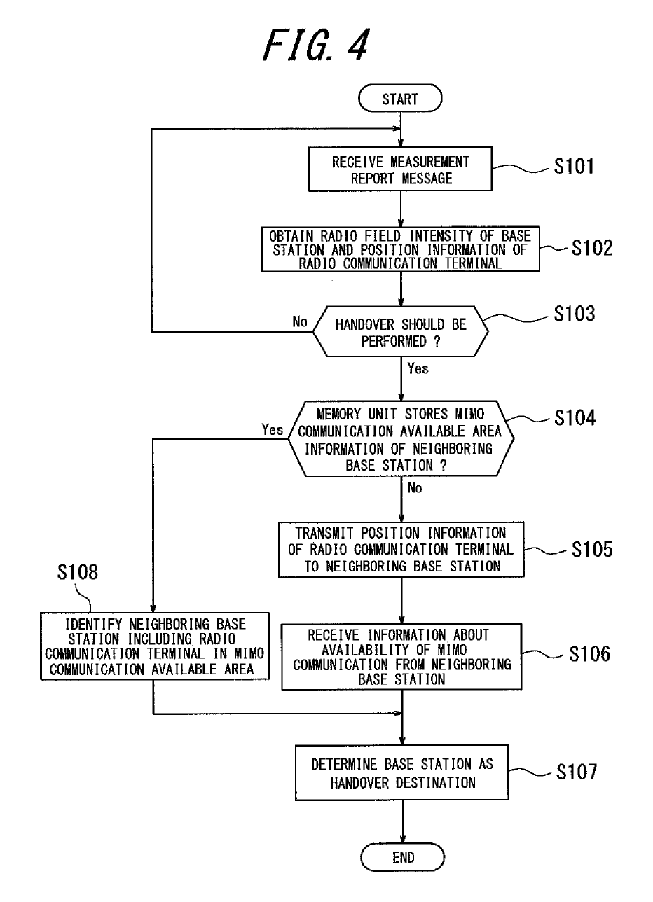

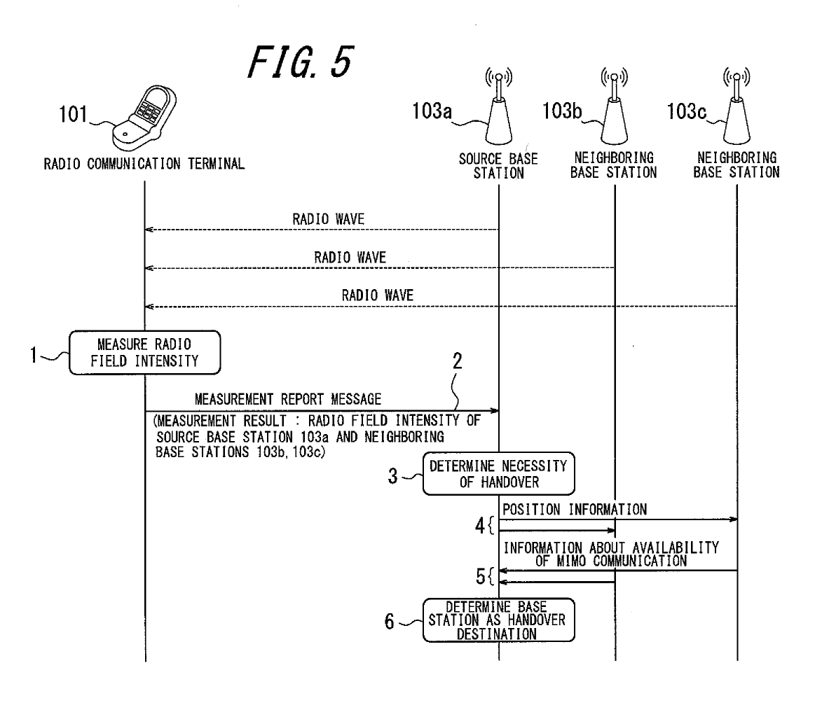

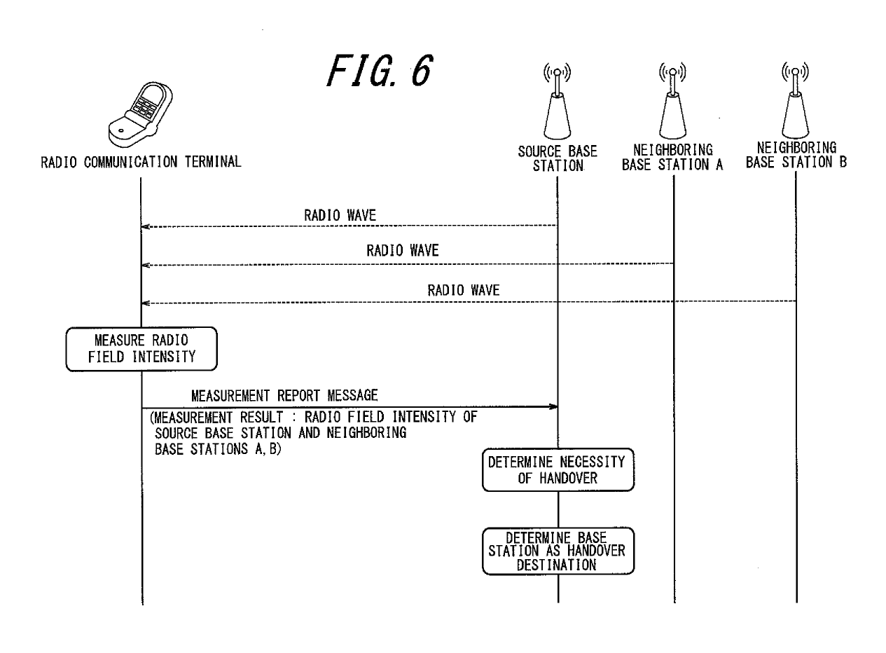

The control unit 127 controls and manages an entire base station 103 including each functional block of the base station 103. The control unit 127 may be constituted by using software executed by any suitable processor such as CPU (Central Processing Unit) or processors specialized for each operation (for example, DSPs (Digital Signal Processors)). The operation of the control unit 127 will be described in detail below in descriptions of FIG. 4 and FIG. 5.

FIG. 3 is a functional block diagram illustrating a schematic configuration of the radio communication terminal according to one embodiment. The radio communication terminal 101 according to the present invention includes a terminal communication unit 131, a position information obtaining unit 133 and a terminal control unit 135.

The terminal communication unit 131 exchanges various information with the base stations 103a-103c and transmits, for example, the measurement report message to the base stations 103a-103c. The position information obtaining unit 133 obtains the position information of the radio communication terminal 101 and is, for example, a GPS (Global Positioning System) receiver for receiving signals from GPS satellites in GPS. The terminal control unit 135 controls and manages an entire radio communication terminal 101 including each functional block of the radio communication terminal 101. The terminal control unit 135 may be constituted by using software executed by any suitable processor such as the CPU (Central Processing Unit) or the processors specialized for each operation (for example, the DSPs (Digital Signal Processors)). The operation of the terminal control unit 135 will be described in detail below in descriptions of FIG. 4 and FIG. 5.

Next, a handover destination determination method employed by the communication system 11 will be described with reference to FIG. 4 and FIG. 5. FIG. 4 is a flowchart illustrating an operation of the base station according to one embodiment. FIG. 5 is a sequence diagram illustrating operations before determination on a handover destination according to one embodiment.

It is assumed that, as illustrated in FIG. 1, the radio communication terminal 101, while performing the MIMO communication with the base station 103a, moves from a position where only the radio waves from the base station 103a may be received into the area A where the radio waves from the base stations 103a-103c may be received.

First, the terminal communication unit 131 of the radio communication terminal 101 receives the radio waves from the base stations 103a-103c and the terminal control unit 135, based on the received radio waves, calculates RSSI (Received Signal Strength Indicator) as the radio field intensity, for example (1 of FIG. 5). The position information obtaining unit 133 obtains, together with the radio field intensity, the position information of the radio communication terminal 101. Then, the terminal control unit 135 controls the terminal communication unit 131 to transmit the measurement report message including the radio field intensity and the position information to the base station 103a (2 of FIG. 5).

The first communication unit 121a of the base station 103a receives the measurement report message (step S101). Then, the control unit 127a, from the measurement report message, obtains the radio field intensity of the base stations 103a-103c and the position information of the radio communication terminal 101 (step S102). Then, the control unit 127a, based on the radio field intensity, determines whether the radio communication terminal 101 should change an access point, that is, the radio communication terminal 101 should perform handover (step S103 and 3 of FIG. 5). For example, when there is a neighboring base station having higher radio field intensity than the base station 103a, the control unit 127a may determine that the radio communication terminal 101 should perform the handover. In the following description, it is assumed that the control unit 127a determines that the radio communication terminal 101 should perform handover to change the access point to one of the neighboring base station 103b and the neighboring base station 103c.

When the control unit 127a determines that the radio communication terminal should perform the handover (“Yes” at step S103), the control unit 127a confirms whether the memory unit 125a stores the MIMO communication available area information of the neighboring base stations 103b and 103c (step S104). When the base station 103a has communicated with the base stations 103b and 103c via the second communication unit 123a and received the MIMO communication available area information of each of the base stations 103b and 103c, the memory unit 125a stores the MIMO communication available area information.

When the memory unit 125a does not store the MIMO communication available area information of the neighboring base stations 103b and 103c (“No” at step S104), the control unit 127a controls the second communication unit 123a to transmit the position information of the radio communication terminal 101 to the neighboring base stations 103b and 103c (step S105 and 4 of FIG. 5). The position information is transmitted by the second communication unit 123a through a resource status request message by X2AP (X2 Application Protocol: a control protocol for a base station communication). Note that the position information of the radio communication terminal 101 is not necessarily transmitted to all neighboring base stations as candidates for the handover destination. For example, a threshold for the RSSI may be set and the position information may be transmitted only to the neighboring base stations having a value of the RSSI equal to or larger than the threshold. The neighboring base station having a smaller value of the RSSI is less likely to be able to perform the MIMO communication. Accordingly, by inquiring of only base stations that are more likely to be able to perform the MIMO communication about availability of the MIMO communication, a processing load in this method may be reduced.

In the following description, since the operation of the base station 103b and that of the base station 103c are identical, the operation of the base station 103b alone will be described. The base station 103b receives the position information of the radio communication terminal 101 via the second communication unit 123b. Then, the control unit 127b, based on the MIMO communication available area information of the base station 103b itself stored in the memory unit 125b and the received position information, determines whether the radio communication terminal 101 is positioned in the MIMO communication available area of the base station 103b itself.

When the radio communication terminal 101 is positioned in the MIMO communication available area of the base station 103b, the control unit 127b determines that the base station 103b may maintain the MIMO communication when selected as the handover destination. Then, the control unit 127b controls the second communication unit 123b to transmit information indicating that the base station 103b is a neighboring base station that may perform the MIMO communication. This information may be made by adding a new parameter to the resource status response message by the X2AP and setting a value of the parameter to 1.

On the other hand, when the radio communication terminal 101 is not positioned in the MIMO communication available area of the base station 103b, the control unit 127b determines that the base station 103b is not able to maintain the MIMO communication when selected as the handover destination. Then, the control unit 127b controls the second communication unit 123b to transmit information indicating that the base station 103b is a neighboring base station that may not perform the MIMO communication. This information may be made by setting the value of the new parameter added to the resource status response message by the X2AP to 0.

Then, the second communication unit 123a of the base station 101a receives information about whether the MIMO communication is available after the handover from the neighboring base stations 103b and 103c (step S106 and 5 of FIG. 5). The control unit 127a determines the neighboring base station capable of performing the MIMO communication as the handover destination (step S107 and 6 of FIG. 5). When there are a plurality of neighboring base stations capable of performing the MIMO communication, the control unit 127a may determine, for example, the base station having the highest radio field intensity among those neighboring base stations as the handover destination.

At step S104, when the memory unit 125a stores the MIMO communication available area information of the neighboring base stations 103b and 103c (“Yes” at step S104), the control unit 127a identifies a neighboring base station that includes the radio communication terminal 101 in its MIMO communication available area (step S108). Then, the control unit 127a determines the neighboring base station capable of performing the MIMO communication as the handover destination (step S107).

According to the present embodiment, as described above, when the memory unit 125a of the source base station 103a stores the MIMO communication available area information of the neighboring base station 103b or 103c, the control unit 127a identifies the neighboring base station that includes the radio communication terminal 101 in its MIMO communication available area and determines the identified neighboring base station as the handover destination (a target base station). Thereby, the radio communication terminal 101 may maintain the MIMO communication after performing the handover.

According to the present embodiment, also, the control unit 127b or 127c of the neighboring base station 103b or 103c, based on the received position information of the radio communication terminal 101 and the MIMO communication available area information stored in the memory unit 125b or 125c, determines whether the radio communication terminal 101 is positioned in the MIMO communication available area. Then, when the radio communication terminal 101 is positioned in the MIMO communication available area, the control unit 127b or 127c controls the second communication unit 123b or 123c to transmit the information indicating that the neighboring base station 103b or 103c may perform the MIMO communication. Since the second communication unit 123a of the source base station 103a receives this information, the control unit 127a may identify the neighboring base station that may perform the MIMO communication. Thereby, the source base station 103a may select the neighboring base station that may perform the MIMO communication as the handover destination (target base station). The operation to determine whether the radio communication terminal 101 is positioned in the MIMO communication available area is performed by each of the neighboring base stations, instead of the source base station. The source base station selects one of the neighboring base stations determined to be able to perform the MIMO communication as the handover destination. Accordingly, concentration of the processing load only on the source base station may be prevented. Since the operation load is distributed to the source base station and the neighboring base stations, an entire system becomes more stable.

According to the present embodiment, further, the MIMO communication available area information is updated based on the position information of the radio communication terminal 101 with which the neighboring base station 103b or 103c has performed the MIMO communication. That is, the MIMO communication available area information is updated every time the neighboring base station 103b or 103c performs the MIMO communication with the radio communication terminal 101. Therefore, a change in the communication environment is reflected in the MIMO communication available area information. Accordingly, regardless of a change of the MIMO communication available area due to the change in the communication environment, the source base station 103a may identify the neighboring base station that may perform the MIMO communication.

Although the present invention is described based on figures and the embodiment, it is to be understood that those who are skilled in the art may easily vary or modify in a multiple manner based on disclosure of the present invention. Accordingly, such variation and modification are included in a scope of the present invention. For example, a function or the like of each member, each method or each step may be rearranged avoiding a logical inconsistency, such that a plurality of components or steps are combined or divided.

According to the embodiment of the present invention described above, although the position information of the radio communication terminal is obtained by the position information obtaining unit of the radio communication terminal, the obtainment of the position information is not limited by the radio communication terminal. For example, when the source base station has the position information and radio wave transmission output values of the source base station itself and the neighboring base stations, the source base station may calculate the position information of the radio communication terminal from the radio field intensity of each base station included in the measurement report message received from the radio communication terminal.

### REFERENCE SIGNS LIST

11 communication network

101 radio communication terminal

103 base station

103a source base station

103b, 103c neighboring base station

113a, 113b, 113c cell

121 first communication unit

123 second communication unit

125 memory unit

127 control unit

131 terminal communication unit

133 position information obtaining unit

135 terminal control unit

A area

1. A base station performing a MIMO (Multiple Input Multiple Output) communication with a radio communication terminal comprising:
a base station control unit configured to, for handover of the radio communication terminal, based on position information of the radio communication terminal and MIMO communication available area information of a neighboring base station adjacent to the base station, to determine a neighboring base station capable of performing the MIMO communication.

2. The base station according to claim 1, further comprising:
a base station communication unit configured to communicate with the neighboring base station; and
a base station memory unit configured to store the MIMO communication available area information of the neighboring base station received from the neighboring base station by the base station communication unit, wherein
the base station control unit, based on the position information and the MIMO communication available area information stored in the base station memory unit, identifies a neighboring base station that includes the radio communication terminal in a MIMO communication available area and determines the identified neighboring base station as a handover destination capable of performing the MIMO communication.

3. The base station according to claim 1, wherein the MIMO communication available area information of the neighboring base station is updated based on position information of a radio communication terminal with which the neighboring base station has performed the MIMO communication.

4. A communication system including a radio communication terminal, a base station terminal performing a MIMO (Multiple Input Multiple Output) communication with the radio communication terminal, and a neighboring base station adjacent to the base station, wherein the base station includes:
a base station communication unit configured to communicate with the neighboring base station; and
a base station control unit configured to, for handover of the radio communication terminal, determine the neighboring base station capable of performing the MIMO communication as a handover destination, and
the neighboring base station includes:
a neighboring base station communication unit configured to communicate with the base station;
a neighboring base station memory unit configured to store MIMO communication available area information of the neighboring base station itself; and
a neighboring base station control unit configured to, when the neighboring base station communication unit receives the position information of the radio communication terminal from the base station communication unit, determine whether the radio communication terminal is positioned in the MIMO communication available area based on the position information and the MIMO communication available area information stored in the neighboring base station memory unit and, when the radio communication terminal is positioned in the MIMO communication available area, to control the neighboring base station communication unit to transmit information indicating that the neighboring base station itself is able to perform the MIMO communication to the base station communication unit.

5. The communication system according to claim 4, wherein the MIMO communication available area information of the neighboring base station is updated based on position information of a radio communication terminal with which the neighboring base station has performed the MIMO communication.

6. A handover destination determination method of a base station performing a MIMO (Multiple Input Multiple Output) communication with a radio communication terminal, comprising a step, for handover of the radio communication terminal determining a neighboring base station capable of performing the MIMO communication as a handover destination based on position information of the radio communication terminal and MIMO communication available area information of the neighboring base station adjacent to the base station.
